(19) United States
(12) Patent Application Publication
(10) Pub. No.: US 2002/0159354 A1
(43) Pub. Date: Oct. 31, 2002

(54) Disk drive apparatus with spindle motor for rotating disk medium, storage system including the apparatus

(76) Inventor: Yoichi Nakabayashi, Ome-shi (JP)

Correspondence Address: PILLSBURY WINTHROP, LLP, P.O. BOX 10500, MCLEAN, VA, 22102, US

(21) Appl. No.: 10/091,525

(22) Filed: Mar. 7, 2002

(30) Foreign Application Priority Data
Apr. 26, 2001 (JP) 2001-130082

(51) Int. Cl. G11B 3/70; G11B 5/84; G11B 7/26

(52) U.S. Cl. 369/53.18; 369/278; 369/53.3

(57) ABSTRACT

When the temperature of an SPM (spindle motor), measured by a temperature sensor, falls outside a predetermined temperature range, a CPU in a disk drive sets, in a disk controller, information concerning the activation of the SPM, to enable a host system to acquire the information. The information includes a temperature control request used to cause the temperature of the SPM to fall within the predetermined temperature range, the present temperature of the SPM and a waiting time required for the SPM to become activatable as a result of temperature control by the host system. The present temperature of the SPM and the waiting time are required for the host system to report a non-functional state of the SPM to the user of the host system

### CROSS-REFERENCE TO RELATED APPLICATIONS

This application is based upon and claims the benefit of priority from the prior Japanese Patent Application No. 2001-130082, filed Apr. 26, 2001, the entire contents of which are incorporated herein by reference.

### BACKGROUND OF THE INVENTION

1. Field of the Invention

The present invention relates to a disk drive apparatus with a spindle motor for rotating a disk medium, and more particularly to a disk drive apparatus suitable for activating the spindle motor when the temperature of the motor significantly differs from an operation-assured value, and a storage system including the apparatus.

2. Description of the Related Art

A hard disk drive (HDD) with a spindle motor for rotating a magnetic disk medium at high speed is known as an example of a disk drive apparatus with a spindle motor for rotating a disk medium. In the HDD, the state of lubrication in the bearing of the spindle motor depends upon the ambient temperature of the HDD. If the ambient temperature of the HDD significantly deviates to, for example, the low-temperature side from the operation-assured temperature of the spindle motor, it is possible that the lubrication of the bearing of the motor may be degraded. This may significantly increase the time required for activating the spindle motor, or may cause the spindle motor to remain in a non-functional state.

To avoid this, for apparatuses with spindle motors, Japanese Patent Application KOKAI Publication No. 6-139749, for example, proposes a technique (hereinafter referred to as “prior art”) for activating the spindle motor in a stable manner. In the prior art, if the temperature of the motor is not higher than a predetermined value, the lubrication of the bearing of the motor is enhanced by heating the motor by a heater. The temperature of the motor is detected by a temperature sensor.

However, even if the prior art is utilized, when the ambient temperature of the apparatus has significantly deviated to the low-temperature side from the operation-assured temperature of the spindle motor, much time is required to heat the motor up to a temperature that enables its stable activation. In this case, a host system, which uses the apparatus, only receives information indicating that the activation of the spindle motor has failed. Therefore, if the apparatus is an HDD, a host system using the HDD, such as a personal computer, must wait a long time before the motor activates.

In this state, the user of the host system cannot know which one of a host system failure, an HDD failure or any other failure is the cause behind the waiting state of the host system. Consequently, the user must continue waiting, or give up using the host system after a certain time elapses.

### BRIEF SUMMARY OF THE INVENTION

The present invention has been developed in light of the above circumstances, and aims to provide an apparatus with a spindle motor for rotating a disk medium, which can execute control to make the temperature of the motor fall within a motor-activation-enabled temperature range, when the motor temperature has fallen outside the temperature range and hence the activation of the motor has failed, and which also can inform the user, via a host system, of a non-functional state of the motor.

According to an aspect of the present invention, there is provided a disk drive apparatus with a spindle motor which rotates a disk medium. The apparatus comprises a temperature sensor, a disk controller and a CPU. The temperature sensor measures the temperature of the spindle motor. The disk controller provides an interface control function for controlling data communication between the host system and the controller. The CPU controls the activation of the spindle motor using a motor driver. When the activation of the spindle motor has failed, and the temperature of the spindle motor, measured by the temperature sensor, falls outside a predetermined temperature range in which the spindle motor can be activated, the CPU sets, in the disk controller, information concerning the activation of the spindle motor to enable the host system to acquire the information. The information includes a temperature control request, a temperature and a waiting time, which are necessary to inform the user of a nonfunctional state of the spindle motor. The temperature control request is used to cause the temperature of the spindle motor to fall within the predetermined temperature range. The mentioned temperature is the temperature of the spindle motor measured by the temperature sensor. The waiting time is a time required for the spindle motor to become activatable as a result of temperature control by the host system.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating the entire configuration of a storage system including a hard disk drive (HDD), according to an embodiment of the invention;

FIG. 2 is a flowchart useful in explaining the operation of an HDD 10 in the embodiment, assumed upon receiving an activation command;

FIG. 3 is a flowchart useful in explaining operations of a host system 20 in the embodiment, which include the operation of issuing the activation command;

FIG. 4 is a flowchart useful in explaining the procedure of estimating a waiting time in the embodiment;

FIG. 5 is a block diagram illustrating the entire configuration of a storage system including a hard disk drive (HDD), according to another embodiment of the invention;

FIG. 6 is a view illustrating a modification of a ROM 161, which stores a heating/cooling capacity table 60; and

FIG. 7 is a view illustrating another modification of the ROM 161, which stores a waiting-time table 70.

### DETAILED DESCRIPTION OF THE INVENTION

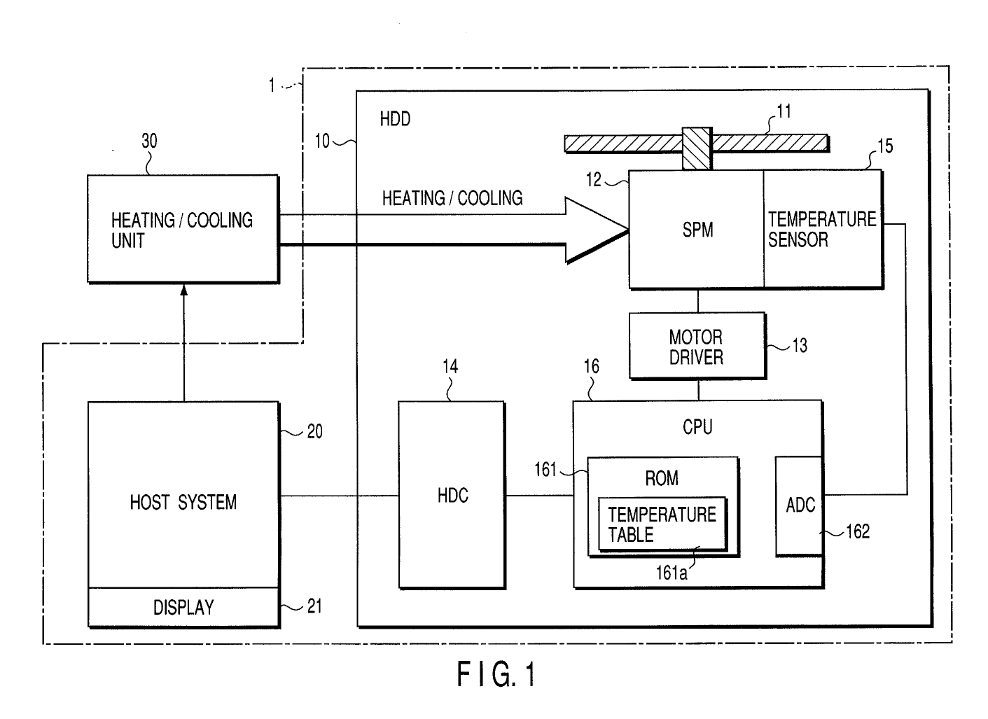

Embodiments in which the present invention is applied to a hard disk drive installed in a vehicle will be described with reference to the accompanying drawings. FIG. 1 is a block diagram illustrating the entire configuration of a storage system including a hard disk drive (HDD), according to an embodiment of the invention. In FIG. 1, a storage system 1 comprises a hard disk drive (hereinafter referred to as an “HDD”) 10, and a host system 20 connected to the HDD 10 to use it.

The HDD 10 comprises a spindle motor (hereinafter referred to as an “SPM”) 12 for rotating a magnetic disk 11 as a magnetic recording medium, a motor driver 13, a disk controller (hereinafter referred to as an “HDC”) 14, a temperature sensor 15 and a CPU 16. The motor driver 13 supplies a current to the SPM 12 to drive it. The HDC 14 is connected to the host system 20. The HDC 14 has an interface control function for receiving commands (a write command and a read command, etc.) transferred from the host system 20, and controlling data transfer between the host system 20 and the HDC 14 itself. The HDC 14 also has a disk control function for controlling data transfer between the magnetic disk 11 and the HDC 14 itself. The temperature sensor 15 is used to measure the temperature of the SPM 12. The temperature 15 is located near the SPM 12.

The CPU 16 controls the entire HDD 10. The operations controlled by the CPU 16 include the operation of activating the HDD 10, which is accompanied by the control of the motor driver 13. The CPU 16 contains, for example, a ROM (Read Only Memory) 161 as a nonvolatile memory, and an A/D (Analog/Digital) converter (hereinafter referred to as an “ADC”) 162. The ROM 161 prestores a control program to be executed by the CPU 16. The ROM 161 also stores a temperature table 161a that presets the upper and lower limits of a temperature range (hereinafter referred to as an “activation-enabled temperature range”) in which the SPM 12 can be activated. The activation-enabled temperature range is a temperature range that assures the operation of the SPM 12. The activation-enabled temperature range differs depending upon the type of the SPM 12, i.e. depending upon whether the SPM is a ball-bearing SPM or a fluid-dynamics-bearing SPM. The ADC 162 converts, into a digital value, an analog output voltage indicative of the temperature of the SPM 12 measured by the temperature sensor 15. If the activation of the SPM 12 has failed, and the temperature of the SPM 12 measured by the temperature sensor 15 falls outside the activation-enabled temperature range indicated by the temperature table 161a, the CPU 16 executes, at regular intervals, i.e., periodically, a process necessary to supply the host system 20 with information concerning the activation of the SPM 12. The information concerning the activation of the SPM 12 includes a request flag (a temperature control request flag) for requesting heating or cooling of the SMP 12, and information indicative of a non-functional state of the SPM. The information indicative of the non-functional state of the SPM includes the present temperature of the SPM 12, and a waiting time required for the SPM 12 to be able to be activated as a result of its heating or cooling.

The host system 20 transmits and receives commands and data to and from the HDC 14 of the HDD 10. The host system 20 is connected to a heating/cooling unit 30. The host system 20 controls the heating/cooling unit 30 on the basis of the information concerning the activation of the SPM 12 and acquired from the HDC 14. In this embodiment, the host system 20 is configured to read, at regular intervals, information indicative of the state of the HDD 10 from the HDC 14 of the HDD 10, if it determines that the activation of the HDD 10 has failed, after supplying the HDD 10 with a command to operate. The information indicative of the state of the HDD 10 includes information concerning the activation of the SPM 12. The host system 20 is, for example, a navigation device main body installed in a vehicle. The host system 20 has a display 21. The heating/cooling unit 30 is, for example, an air conditioner installed in a vehicle and having cooling/heating functions for changing the internal temperature of the vehicle.

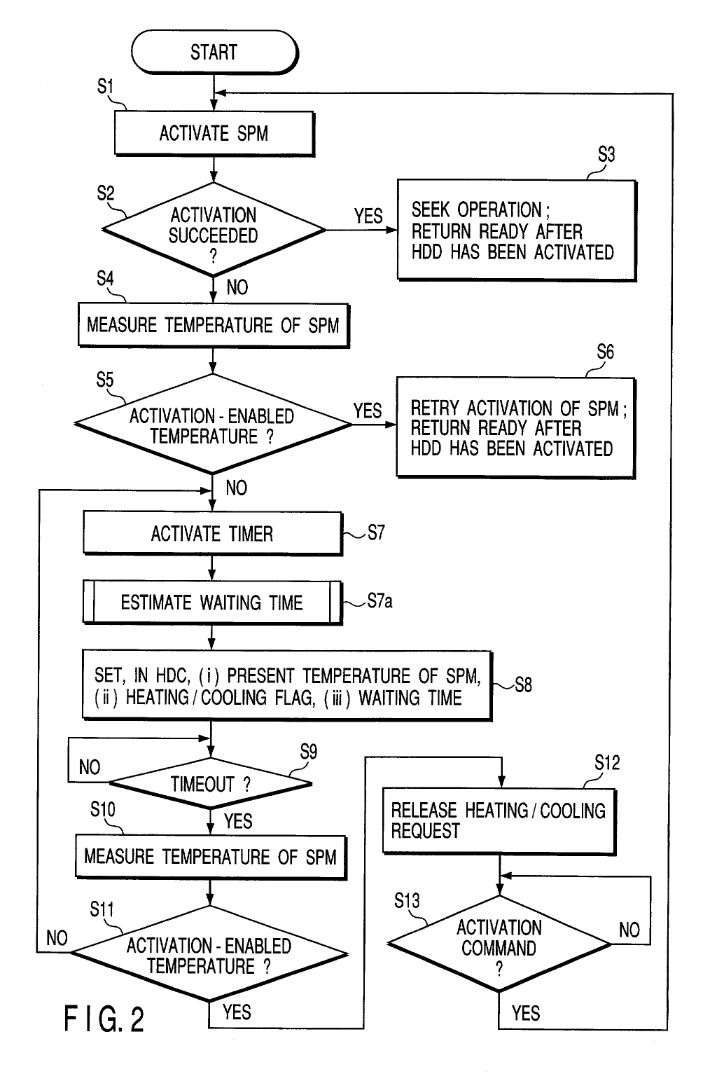

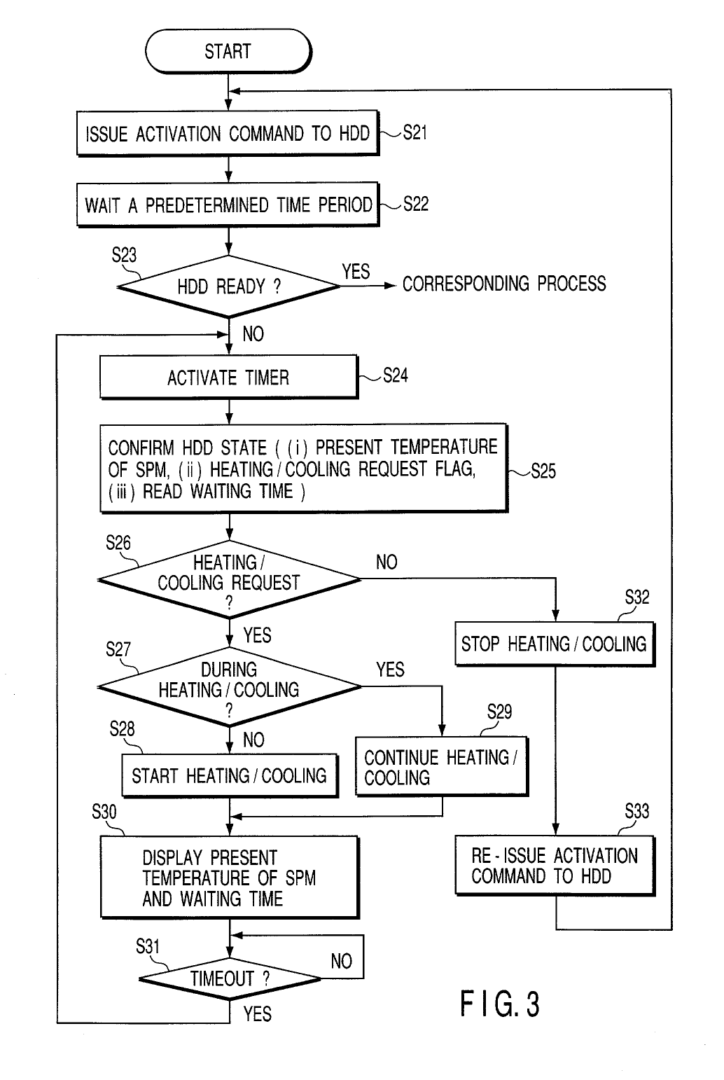

Referring to the flowcharts of FIGS. 2 and 3, the operation of the configuration of FIG. 1 will be described. First, suppose that the host system 20 has supplied the HDD 10 with a command to operate (step S21). The commend from the host system 20 is received by the HDC 14, which in turn transfers it to the CPU 16. Upon receiving the command, the CPU 16 controls the motor driver 13 so as to activate the SPM 12 (step S1).

The motor driver 13 generates a pulse each time the SPM 12 executes one rotation. A string of pulses generated in synchronism with the rotation of the SPM 12 are output to the CPU 16. The CPU 16 calculates the rotational speed of the SPM 12 on the basis of a time interval between adjacent ones of the pulses output from the motor driver 13. The CPU 16 determines whether or not the activation of the SPM 12 has succeeded, depending upon whether or not the rotational speed of the SPM 12 had reached a predetermined range, i.e., a steady rotation state, before a predetermined period of time elapses (step S2). The predetermined rotational speed range is set at 4200 rpm+0.1%.

When the activation of the SPM 12 has succeeded, the CPU 16 executes a seek operation for moving a head (read/write head)(not shown) to a predetermined track on the magnetic disk 11. After the HDD 10 has come to be able to be used by the host system 20, the CPU 16 returns a ready signal, which indicates the ready state of the HDD 10, to the host system 20 via the HDC 14 (step S3). The state in which the HDD 10 has come to be able to be used by the host system 20 indicates that all the activation of the HDD 10 including the seek operation has been completed.

On the other hand, when the activation of the SPM 12 has failed, the CPU 16 reads, via the ADC 162, the temperature of the SPM 12 measured by the temperature sensor 15 (and indicated by the output voltage of the temperature sensor 15) (step S4). Then, the CPU 16 compares the read temperature with the upper and lower limits of the activation-enabled temperature range indicated by the temperature table 161a, thereby determining whether or not the temperature of the SPM 12 falls within the temperature range (step S5).

If the temperature of the SPM 12 falls within the activation-enabled-temperature range, the CPU 16 determines that the cause behind the activation failure of the SPM 12 is that other than the temperature of the SPM 12, thereby retrying the activation of the SPM 12 (step S6). If the retrial of the activation of the SPM 12 has succeeded, the CPU 16 executes the next operation (such as the seek operation). After finishing the entire activation of the HDD 10, the CPU 16 returns a ready signal to the host system 20 via the HDC 14.

If the temperature of the SPM 12 falls outside the activation-enabled-temperature range (step S5), the CPU 16 determines that this is the cause behind the activation failure of the SPM 12.

If the temperature of the SPM 12 is lower than the lower limit of the activation-enabled-temperature range, the lubrication of the bearing of the SPM 12 is degraded, with the result that the activation time period of the SPM 12 may be significantly lengthened, and at worst, the SPM 12 may remain non-functional permanently. In particular, in a case where a fluid-dynamics-bearing SPM, which employs, in place of the ball bearing, a fluid dynamics bearing of a less runout than the ball bearing, is used as the SPM 12, the above problem is more conspicuous. This is because the dependency of the activation torque (i.e., the amount of energy necessary for activation) of the fluid-dynamics-bearing SPM upon the temperature is greater at low temperatures than that of the ball-bearing SPM.

Further, if the temperature of the SPM 12 is higher than the higher limit of the activation-enabled-temperature range, a phenomenon may occur in which the center of rotation of the SPM 12 varies and the SPM 12 cannot be reliably activated, i.e., a non-repeatable runout (NRRO) may occur.

Where the HDD 10 is installed in a vehicle as in the embodiment, it is possible that the temperature of the SPM 12 will fall outside the activation-enabled-temperature range. In light of this, if the activation of the SPM 12 has failed because its temperature is outside the activation-enabled-temperature range (step S5), the CPU 16 activates a timer, assuming that the host system 20 periodically reads, from the HDC 14, information indicative of the state of the HDD 10 (step S7). Thereafter, the CPU 16 estimates a waiting time required for the SPM 12 to reach the activation-enabled temperature as a result of the heating or cooling of the SPM by the heating/cooling unit 30 (step S7a). A method for estimating the waiting period will be described later.

Subsequently, in order to report the current state of the HDD 10 to the host system 20, the CPU 16 sets information concerning the activation of the SPM 12 in a predetermined register block (not shown) in the HDC 14 (step S8). The information concerning the activation of the SPM 12 includes (i) the present temperature of the SPM 12, (ii) a heating/cooling request flag and (iii) the waiting time estimated at the step S7a. The heating/cooling request flag indicates that the HDD 10 is in a state of requesting its heating or cooling. As can be easily understood, if the temperature of the SPM 12 is lower than the lower limit of the activation-enabled-temperature range, the heating/cooling request flag is set at a value, which indicates that the HDD 10 is in a state wherein the heating of the SPM 12 is required (i.e., in a heating-requested state). Similarly, if the temperature of the SPM 12 is higher than the higher limit of the activation-enabled-temperature range, the heating/cooling request flag is set at a value, which indicates that the HDD 10 is in a state wherein the cooling of the SPM 12 is required (i.e., in a cooling-requested state).

If the host system 20 has output an activation command to the HDD 10 at the step S21, and receives no ready signal from the HDD 10 even after a predetermined time period elapses (steps S22 and S23), the host system 20 first activates a timer (step S24). Subsequently, to confirm the state of the HDD 10, the host system 20 reads, from the predetermined register block in the HDC 14 of the HDD 10, the aforementioned information items (i), (ii) and (iii), i.e. the present temperature of the SPM 12, the heating/cooling request flag, and the waiting time required for the SPM 12 to reach the activation-enabled temperature (step S25). This means that the information items (i), (ii) and (iii) are indirectly reported from the CPU 16 of the HDD 10 to the host system 20.

After that, the host system 20 determines, from the heating/cooling request flag read from the HDC 14, whether or not the heating or cooling of the SPM 12 is requested (step S26). If the heating or cooling of the SPM 12 is requested and the heating/cooling unit 30 is not executing heating or cooling (step S27), the host system 20 causes the heating/cooling unit 30 to start the heating or cooling of the SPM 12 (step S28). At this time, the SPM 12 is heated or cooled by heating or cooling air supplied from the heating/cooling unit 30. However, in the embodiment in which an air conditioner with heating/cooling functions installed in a vehicle is used as the heating/cooling unit 30, the interior of the vehicle is heated or cooled, as well as the SPM 12 and the HDD 10. On the other hand, if heating or cooling of the SPM 12 is requested by the heating/cooling request flag, and if the heating/cooling unit 30 is executing heating or cooling (steps S26 and S27), the host system 20 controls the heating/cooling unit 30 so as to continue the heating or cooling (step S29). As can be easily understood, the CPU 16 of the HDD 10 indirectly controls the heating/cooling unit 30, using the heating/cooling request flag.

Furthermore, the host system 20 displays, for example, the present temperature of the SPM 12 (HDD 10) and a waiting time required for the SPM 12 to reach the activation-enabled temperature, on the display 21, on the basis of temperature and waiting time information read from the HDD 10 (step S30). At this time, it would be advisable to display, instead of merely displaying the present temperature of the HDD, a message, for example, that “the present temperature of the HDD is XX ° C., which is extremely lower (higher) than the operation-assured temperature, and therefore the HDD cannot be activated”.

By the display operation at the step S30, the user can confirm the state of the HDD on the display 21, and can know the reason why the HDD 10 cannot be activated, and when the HDD 10 can be activated. On the other hand, in the prior art, if the HDD 10 cannot be activated because of, for example, a low temperature, the HDD 10 is heated as in the embodiment of the invention. However, in the prior art, the user does not receive information indicating the heating operation, and hence they are anxious about why the HDD cannot be activated or when it can be activated. The embodiment of the invention solves this problem. The host system 20 executes the data reading at the step S25 at regular intervals, using a timer, in order to update the display contents of the display 21 at the regular intervals (steps S31 and S24).

On the other hand, the CPU 16 of the HDD 10 waits for the timer, activated at the step S7, to measure a predetermined time period and generate a time-out signal, after setting the information items (i), (ii) and (iii) in the HDC 14 at the step S8 (step S9). After the time-out of the timer, the CPU 16 reads the temperature of the SPM 12 measured by the temperature sensor 15 via the ADC 162 (step S10). At this time, the CPU 16 determines whether or not the temperature of the SPM 12 measured by the temperature sensor 15 falls within the activation-enabled-temperature range indicated by the temperature table 161a (step S1). If the temperature of the SPM 12 falls outside the activation-enabled-temperature range, the CPU 16 re-executes the process at the step S7 et seq. In other words, as long as the temperature of the SPM 12 falls outside the activation-enabled-temperature range, the CPU 16 periodically repeats the process of setting the information items (i), (ii) and (iii) in the HDC 14.

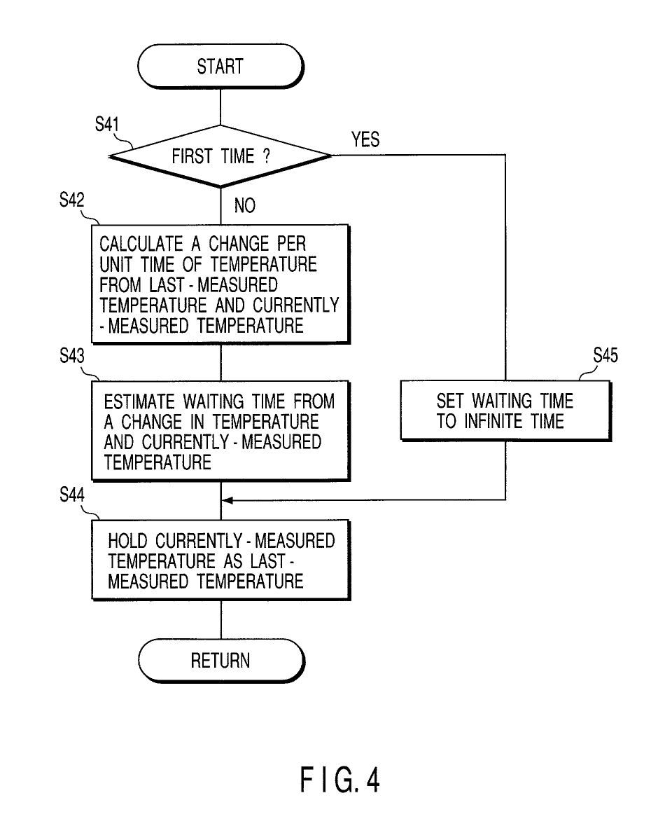

Referring now to the flowchart of FIG. 4, a description will be given of a procedure for estimating the aforementioned waiting time, using the CPU 16. Suppose that the CPU 16 holds, for example, the temperature (the last-measured temperature) of the SPM 12 measured by the temperature sensor 15 in the last loop. If the CPU 16 holds the last-measured temperature, it calculates a change in temperature per a predetermined time period on the basis of the last-measured temperature and a temperature measured in the present loop after a predetermined time period elapses from the last loop (steps S41 and S42). Subsequently, the CPU 16 estimates (calculates), from the change in temperature and the temperature measured in the present loop, the time required for the temperature of the SPM 12 to reach the activation-enabled-temperature range, i.e. the waiting time (step S43). Then, the CPU 16 holds the temperature, measured in the present loop, as the last-measured temperature (step S44).

This estimation procedure is effective in a case where the CPU 16 of the HDD 10 cannot detect the heating/cooling capacity of the heating/cooling unit 30, as in the embodiment. However, since the last-measured temperature does not exist when the state of the HDD 10, assumed when the activation of the SPM 12 has failed, is reported for the first time (step S8), the aforementioned waiting time cannot be estimated (calculated). In light of this, in the first-time-reporting process, a predetermined time period, for example, an infinite time period, is used as the waiting time (steps S41 and S45). In this case, the host system 20 displays, for example, a message that “a waiting time is being calculated”, or a temporary waiting time, on the display 21 in accordance with predetermined-time information indicating the infinite time period. Further, since the state of the HDD 10 is reported at regular intervals, and hence an initial waiting time can be calculated after a predetermined time period elapses from the first-time-reporting process, a time period required before displaying the initial waiting time may be displayed. Furthermore, to calculate the waiting time, a temperature measured a number n of loops before may be used in place of the last-measured temperature. As can be understood, if n=1, the temperature measured a number n of loops before is the last-measured temperature.

When the temperature of the SPM 12 has reached the activation-enabled-temperature range as a result of heating or cooling executed by the heating/cooling unit 30 under the control of the host system 20 (step S11), the CPU 16 changes, in order to prevent the HDD 10 from being excessively heated or cooled, the heating/cooling request flag set in the HDC 14 to a heating/cooling-request-released state, thereby withdrawing the heating/cooling request (step S12). After that, the CPU 16 waits for a command to re-activate the HDD 10, which is supplied from the host system 20 (step S13).

If the heating/cooling flag, contained in the information read from the HDC 14 at the step S25, is changed to the heating/cooling-request-released state (step S26), the host system 20 stops the heating/cooling operation of the heating/cooling unit 30 (step S32). The host system 20 resupplies the HDD 10 with a command to operate to reactivate the HDD 10 (step S33).

In the above-described embodiment, the HDD 10 with the SPM 12 is installed in a vehicle, and the host system 20 that uses the HDD 10 is a navigation system main body. The host system 20 may be, for example, a personal computer, which contains the HDD 10. In this case, however, a heating/cooling unit 30 is necessary, which is dedicated to the heating/cooling of the SPM 12 included in the HDD 10 and can be controlled by the host system 20. On the other hand, in the embodiment in which an air conditioner installed in a vehicle can be used as the heating/cooling unit 30, it is not necessary to prepare a heating/cooling unit dedicated to heating/cooling the SPM 12 of the HDD 10.

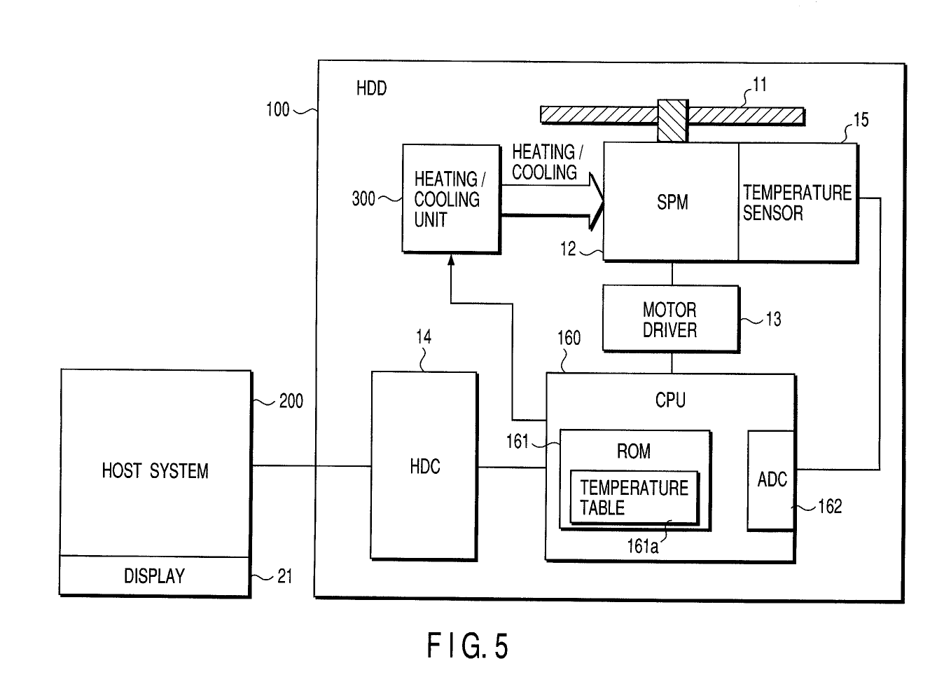

Moreover, as shown in the storage system of FIG. 5, an HDD 100 equipped with a heating/cooling unit 300 dedicated to heating/cooling the SPM 12 may be employed in place of the HDD 10. In the case of FIG. 5, the heating/cooling unit 300 is located near the SPM 12. In the HDD 100, if the activation of the SPM 12 has failed because the temperature of the SPM 12 falls outside the activation-enabled-temperature range, it is sufficient if a CPU 160 corresponding to the CPU 16 in FIG. 1 controls the heating/cooling unit 300. In this case, since a host system 200 corresponding to the host system 20 in FIG. 1 does not have to control the heating/cooling unit 300, it is sufficient if the CPU 160 reports the temperature of the SPM 12 and the waiting time to the host system 200.

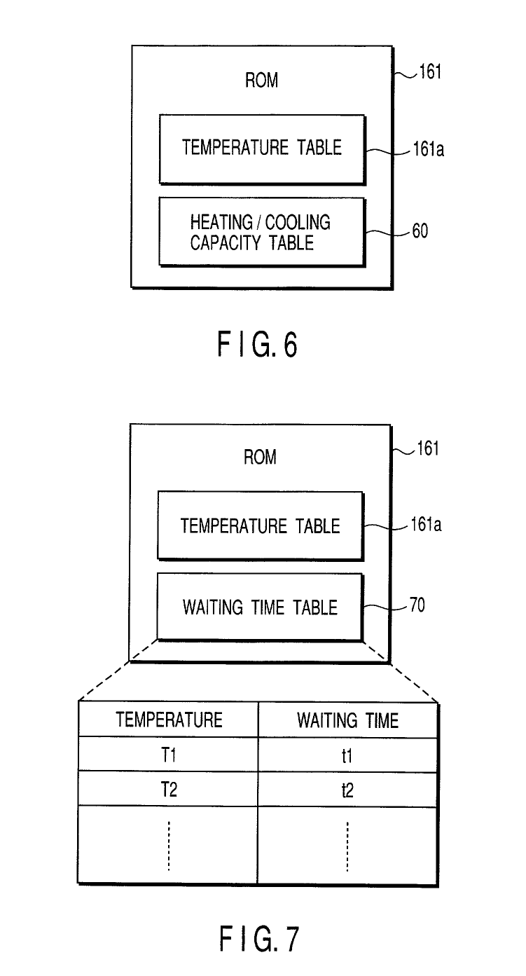

Also, in the system of FIG. 5, the heating/cooling unit 300 is prepared to heat/cool the SPM 12. Therefore, as shown in FIG. 6, a heating/cooling capacity table 60, in which the heating/cooling capacity information of the heating/cooing unit 300 is registered, may be prestored in the ROM 161. In this case, the CPU 160 can estimate (calculate) the waiting time only from the present temperature of the SPM 12, using the heating/cooling capacity information registered in the heating/cooling capacity table 60. Furthermore, as shown in FIG. 7, a waiting-time table 70, in which the relationship between the temperature of the SPM 12 and the waiting time is registered, may be prestored in the ROM 161 in place of the heating/cooling capacity table 60. In this case, the CPU 160 can estimate (calculate) the waiting time only from the present temperature of the SPM 12, referring to the waiting-time table 70. The waiting-time table 70 can be easily prepared by calculating waiting time periods corresponding to respective temperatures of the SPM 12 on the basis of the hating/cooling capacity of the heating/cooling unit 300 and the respective temperatures of the SPM 12.

Further, in the above embodiment, the temperature sensor 15 for measuring the temperature of the SPM 12 is located near the SPM 12. However, the relationship, for example, between the upper and lower limit temperatures of the SPM 12, at which the SPM 12 can be activated, and the temperatures of a particular portion of the HDD 10 assumed at the upper and lower limit temperatures of the SPM 12 can be predetermined. Accordingly, the temperature sensor 15 may be configured to measure the temperature of a particular portion of the HDD 10 other than the SPM 12. This means that the temperature sensor 15 indirectly measures the temperature of the SPM 12.

Furthermore, in the above embodiment, the SPM 12 is heated if its temperature is lower than the lower limit of the activation-enabled-temperature range, and cooled if its temperature is higher than the higher limit of the range. However, control may be executed in only one of these cases, e.g. where the temperature is lower than the lower limit. Also in this case, the host system 20 can inform the user of the activation-failed state of the SPM 12, each time the activation of the SPM 12 has failed because the temperature of the SPM 12 is lower than the lower limit of the activation-enabled-temperature range.

In addition, in the above embodiment, information indicative of the state of the HDD 10 of the CPU 16 is set in the HDC 14 at regular intervals, while the host system 20 periodically reads it. However, information indicative of the state of the HDD 10 may be transferred to the host system 20 from the HDC 14, each time the CPU 16 sets, in the HDC 14, the information indicative the state of the HDD 10. To this end, it is necessary to provide the HDC 14 with an interface function for generating an interrupt from the HDC 14 to the host system 20. In this case, each time the CPU 16 sets, in the HDC 14, information indicative the state of the HDD 10, an interrupt is generated from the HDC 14 to the host system 20. When the host system 20 has received the interrupt from the HDC 14, the information indicative the state of the HDD 10 is transferred from the HDC 14 to the host system 20.

Although the above embodiment is directed to a case where a storage system includes an HDD (Hard Disk Drive) with an SPM for rotating a magnetic disk, the present invention is not limited to this. The invention is also applicable to a disk drive other than the HDD, such as a magneto-optical disk drive with an SPM for rotating a magneto-optical disk, an optical disk drive with an SPM for rotating an optical disk, or a CD-ROM drive with an SPM for rotating a CD-ROM, etc.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive apparatus with a spindle motor which rotates a disk medium, comprising:
a motor driver configured to supply a current to the spindle motor to drive the spindle motor;
a temperature sensor configured to measure a temperature of the spindle motor;
a disk controller connected to a host system which uses the disk drive apparatus, the disk controller providing an interface control function which controls data communication between the host system and the disk drive apparatus; and
a CPU configured to control activation of the spindle motor using the motor driver, the CPU setting, in the disk controller, information concerning the activation of the spindle motor to enable the host system to acquire the information, when the activation of the spindle motor has failed, and the temperature of the spindle motor, measured by the temperature sensor, falls outside a predetermined temperature range in which the spindle motor can be activated, the information including a temperature control request used to cause the temperature of the spindle motor to fall within the predetermined temperature range, a present temperature of the spindle motor measured by the temperature sensor, and a waiting time required for the spindle motor to become activatable as a result of temperature control by the host system, the present temperature of the spindle motor and the waiting time being required for the host system to report a nonfunctional state of the spindle motor to a user of the host system.

2. The disk drive apparatus according to claim 1, wherein the CPU determines that the temperature of the spindle motor falls outside the predetermined temperature range, if the temperature of the spindle motor, measured by the temperature sensor, is lower than a lower limit of the predetermined temperature range.

3. The disk drive apparatus according to claim 1, wherein the CPU determines that the temperature of the spindle motor falls outside the predetermined temperature range, if the temperature of the spindle motor, measured by the temperature sensor, is higher than a higher limit of the predetermined temperature range.

4. The disk drive apparatus according to claim 1, wherein the CPU estimates the waiting time on the basis of the present temperature of the spindle motor and a change per unit time in the temperature of the spindle motor.

5. The disk drive apparatus according to claim 1, wherein the CPU periodically sets, in the disk controller, updated information concerning the activation of the spindle motor, during the time the temperature of the spindle motor falls outside the predetermined temperature range.

6. The disk drive apparatus according to claim 1, further comprising a nonvolatile memory which prestores the predetermined temperature range, the predetermined temperature range being inherent in a type of the spindle motor, and wherein the CPU compares the temperature of the spindle motor, measured by the temperature sensor, with the predetermined temperature range stored in the nonvolatile memory, thereby determining whether the temperature of the spindle motor falls outside the predetermined temperature range.

7. A disk drive apparatus with a spindle motor which rotates a disk medium, comprising:
a motor driver configured to supply a current to the spindle motor to drive the spindle motor;
a temperature sensor configured to measure a temperature of the spindle motor;
a heating/cooling unit configured to heat or cool at least the spindle motor;
a disk controller connected to a host system which uses the disk drive apparatus, the disk controller providing an interface control function which controls data communication between the host system and the disk drive apparatus; and
a CPU configured to control activation of the spindle motor using the motor driver,
wherein when the activation of the spindle motor has failed, and the temperature of the spindle motor, measured by the temperature sensor, falls outside a predetermined temperature range in which the spindle motor can be activated,
the CPU causes the heating/cooling unit to heat or cool at least the spindle motor so as to make the temperature of the spindle motor, measured by the temperature sensor, fall within the predetermined temperature range, and
the CPU sets, in the disk controller, information concerning the activation of the spindle motor to enable the host system to acquire the information, the information including a present temperature of the spindle motor measured by the temperature sensor, and a waiting time required for the spindle motor to become activatable as a result of heating or cooling by the heating/cooling unit, the present temperature of the spindle motor and the waiting time being required for the host system to report a non-functional state of the spindle motor to a user of the host system.

8. The disk drive apparatus according to claim 7, wherein the CPU determines that the temperature of the spindle motor falls outside the predetermined temperature range, if the temperature of the spindle motor, measured by the temperature sensor, is lower than a lower limit of the predetermined temperature range.

9. The disk drive apparatus according to claim 7, wherein the CPU determines that the temperature of the spindle motor falls outside the predetermined temperature range, if the temperature of the spindle motor, measured by the temperature sensor, is higher than a higher limit of the predetermined temperature range.

10. The disk drive apparatus according to claim 7, wherein the CPU estimates the waiting time on the basis of the present temperature of the spindle motor and a change per unit time in the temperature of the spindle motor.

11. The disk drive apparatus according to claim 7, further comprising a nonvolatile memory which prestores information indicative of a heating/cooling capacity of the heating/cooling unit, and wherein the CPU estimates the waiting time on the basis of the temperature of the spindle motor measured by the temperature sensor, and the information stored in the nonvolatile memory and indicative of the heating/cooling capacity of the heating/cooling unit.

12. The disk drive apparatus according to claim 7, further comprising a nonvolatile memory which prestores a table in which the relationship between the temperature of the spindle motor and the waiting time is entered, and wherein the CPU estimates the waiting time, referring to the table, on the basis of information concerning the temperature of the spindle motor measured by the temperature sensor.

13. The disk drive apparatus according to claim 7, wherein the CPU periodically sets, in the disk controller, updated information concerning the activation of the spindle motor, during the time the temperature of the spindle motor falls outside the predetermined temperature range.

14. The disk drive apparatus according to claim 7, further comprising a nonvolatile memory which prestores the predetermined temperature range, the predetermined temperature range being inherent in a type of the spindle motor, and wherein the CPU compares the temperature of the spindle motor, measured by the temperature sensor, with the predetermined temperature range stored in the nonvolatile memory, thereby determining whether the temperature of the spindle motor falls outside the predetermined temperature range.

15. A storage system comprising:
a disk drive with a spindle motor which is powered by a current supplied from a motor driver and rotates a disk medium;
a host system connected to the disk drive to use the disk drive, and also connected to a heating/cooling unit, the heating/cooling unit capable of heating or cooling at least the disk drive; and
a display configured to display information output from the host system,
wherein the disk drive includes:
a temperature sensor configured to measure a temperature of the spindle motor;
a disk controller which provides an interface control function which controls data communication between the host system and the disk drive; and
a CPU configured to control activation of the spindle motor using the motor driver, the CPU setting, in the disk controller, information concerning the activation of the spindle motor to enable the host system to acquire the information, when the activation of the spindle motor has failed, and the temperature of the spindle motor, measured by the temperature sensor, falls outside a predetermined temperature range in which the spindle motor can be activated, the information including a temperature control request used to cause the temperature of the spindle motor to fall within the predetermined temperature range, a present temperature of the spindle motor measured by the temperature sensor, and a waiting time required for the spindle motor to become activatable as a result of temperature control by the host system, the present temperature of the spindle motor and the waiting time being required for the host system to report a nonfunctional state of the spindle motor to a user of the host system,
and wherein the host system acquires, from the disk controller, the information concerning the activation of the spindle motor and set in the disk controller, the host system controlling the heating/cooling in accordance with the temperature control request contained in the information concerning the activation of the spindle motor, and also displaying, on the display, information which reflects the present temperature of the spindle motor and the waiting time, contained in the information concerning the activation of the spindle motor.

16. The storage system according to claim 15, wherein the CPU periodically sets, in the disk controller, updated information concerning the activation of the spindle motor, during the time the temperature of the spindle motor falls outside the predetermined temperature range.

17. The storage system according to claim 15, wherein the host system, the display and the heating/cooling unit are all installed in a vehicle.

18. The storage system according to claim 17, wherein the heating/cooling unit is an air conditioner with a heating/cooling function capable of varying an internal temperature of the vehicle.

19. A storage system comprising:
a disk drive with a spindle motor which is powered by a current supplied from a motor driver and rotates a disk medium;
a host system connected to the disk drive to use the disk drive; and
a display configured to display information output from the host system,
wherein the disk drive includes:
a temperature sensor configured to measure a temperature of the spindle motor;
a heating/cooling unit configured to heat or cool at least the spindle motor;
a disk controller which provides an interface control function which controls data communication between the host system and the disk drive; and
a CPU configured to control activation of the spindle motor using the motor driver,
wherein when the activation of the spindle motor has failed, and the temperature of the spindle motor, measured by the temperature sensor, falls outside a predetermined temperature range in which the spindle motor can be activated,
the CPU causes the heating/cooling unit to heat or cool at least the spindle motor so as to make the temperature of the spindle motor, measured by the temperature sensor, fall within the predetermined temperature range, and
the CPU sets, in the disk controller, information concerning the activation of the spindle motor to enable the host system to acquire the information, the information including a present temperature of the spindle motor measured by the temperature sensor, and a waiting time required for the spindle motor to become activatable as a result of heating or cooling by the heating/cooling unit, the present temperature of the spindle motor and the waiting time being required for the host system to report a non-functional state of the spindle motor to a user of the host system,
and wherein the host system acquires, from the disk controller, the information concerning the activation of the spindle motor and set in the disk controller, the host system displaying, on the display, information which reflects the present temperature of the spindle motor and the waiting time, contained in the information concerning the activation of the spindle motor.

20. The storage system according to claim 19, wherein the CPU periodically sets, in the disk controller, updated information concerning the activation of the spindle motor, during the time the temperature of the spindle motor falls outside the predetermined temperature range.

21. A method, used in a system including a disk drive with a spindle motor which rotates a disk medium, for displaying a non-functional state of the spindle motor when activation of the spindle motor has failed, the method comprising:
determining, when the activation of the spindle motor has failed, whether a temperature of the spindle motor falls outside a predetermined temperature range in which the spindle motor can be activated;
generating, in the disk drive, information concerning the activation of the spindle motor, when the temperature of the spindle motor falls outside the predetermined temperature range, the information including a temperature control request used to cause the temperature of the spindle motor to fall within the predetermined temperature range, a present temperature of the spindle motor measured by the temperature sensor, and a waiting time required for the spindle motor to become activatable as a result of temperature control by a host system which uses the disk drive;
acquiring, in the host system, the information concerning the activation of the spindle motor from the disk drive;
controlling, in the host system, a heating/cooling unit in accordance with the temperature control request contained in the information, thereby at least heating or cooling the disk drive: and
displaying, in the host system, a non-functional state of the spindle motor on a display, the nonfunctional state reflecting the present temperature of the spindle motor and the waiting time contained in the information.

22. A method, used in a system including a disk drive with a spindle motor which rotates a disk medium, for displaying a non-functional state of the spindle motor when activation of the spindle motor has failed, the method comprising:
determining, when the activation of the spindle motor has failed, whether a temperature of the spindle motor falls outside a predetermined temperature range in which the spindle motor can be activated;
heating or cooling, when the temperature of the spindle motor falls outside the predetermined temperature range, at least the spindle motor by a heating/cooling unit installed in the disk drive, so as to make the temperature of the spindle motor fall within the predetermined temperature range, and generating, in the disk drive, information concerning the activation of the spindle motor, the information including a present temperature of the spindle motor, and a waiting time required for the spindle motor to become activatable as a result of heating or cooling by the heating/cooling unit;
acquiring, in a host system which uses the disk drive, the information concerning the activation of the spindle motor from the disk drive; and
displaying, in the host system, a non-functional state of the spindle motor on a display, the nonfunctional state reflecting the present temperature of the spindle motor and the waiting time contained in the information.
